(19) United States
(12) Patent Application Publication
(10) Pub. No.: US 2024/0421372 A1
(43) Pub. Date: Dec. 19, 2024

(54) SPENT SECONDARY BATTERY CATHODE REGENERATION SOLUTION AND CATHODE REGENERATION METHOD USING THE SAME

(71) Applicant: KOREA INSTITUTE OF SCIENCE AND TECHNOLOGY, Seoul (KR)

(72) Inventors: Min Ah LEE, Seoul (KR); Ji Hyun HONG, Seoul (KR); Hun Gi JUNG, Seoul (KR); Jin Kwan CHOI, Seoul (KR); Kyung Yoon CHUNG, Seoul (KR); Ui Chan HWANG, Seoul (KR)

(21) Appl. No.: 18/403,060

(22) Filed: Jan. 3, 2024

(30) Foreign Application Priority Data
Jun. 16, 2023 (KR) 10-2023-0077763

(51) Int. Cl. H01M 10/54; H01M 4/02; H01M 4/04

(52) U.S. Cl. CPC H01M 10/54; H01M 4/0416; H01M 2004/028

(57) ABSTRACT

Provided are a regeneration solution of a spent secondary battery cathode material, the regeneration solution including p-type redox molecules, a solvent, and a lithium salt, in which the p-type redox molecules have a reduction potential that is higher than or equal to 1.55 volt (V) and lower than or equal to 3.7 V with respect to a reduction potential (vs Li/Li₊) of lithium, a method of regenerating a cathode material and a regenerated cathode material using this, and a method of recycling the regeneration solution.

### CROSS-REFERENCE TO RELATED APPLICATION

This application claims the benefit of Korean Patent Application No. 10-2023-0077763filed on Jun. 16, 2023, in the Korean Intellectual Property Office, the entire disclosure of which is incorporated herein by reference for all purposes.

### BACKGROUND

### 1. Field of the Invention

One or more embodiments relate to a spent secondary battery cathode regeneration solution and a recycled secondary battery using the same.

### 2. Description of the Related Art

Lithium secondary batteries have advantages such as high energy density, light weight, high power, stable discharge characteristics, and stability over a wide range of temperatures. These days, lithium secondary batteries are widely used in small home appliances and precision devices, and recently, the use of medium and large-sized lithium secondary batteries is rapidly increasing.

Recently, a large amount of spent batteries is expected to be generated due to the rapidly increasing use of lithium secondary batteries, and a technology for recycling secondary batteries is also attracting great attention. In particular, among various components in secondary batteries, there is an urgent need for a technology for recycling a cathode active material, which has a limited amount of reserves and is expensive as a raw material among the components.

Meanwhile, among cathode recycling methods used in the related art, a direct recycling (or cathode regeneration) method, through which an active material can be regenerated by consuming relatively low energy while maintaining a particle shape of a spent cathode material, is advantageous that a reusable cathode material can be directly obtained from a spent battery without requiring a re-synthesis process. The direct recycling method reported so far includes a solid-state reaction, hydrothermal synthesis, eutectic salt synthesis, and the like, however, each of the methods requires precise analysis of a lithium composition requiring high cost, requires a high reaction temperature of hundreds of degrees and a high pressure condition, or requires an inert atmosphere without oxygen, making it difficult to realize a process for large quantity and to commercialize due to high cost.

Therefore, the inventors have completed the present disclosure in order to solve the problems of the existing cathode active material recycling method as described above.

### SUMMARY

The present disclosure has been made to solve the above problems, and an object thereof is to provide a regeneration solution of a spent secondary battery cathode capable of easily obtaining a regenerated cathode material having an original composition, by immersing a partially or entirely delithiated cathode or a cathode active material in the regeneration solution at room temperature and ambient pressure for a certain period of time, without the use of a toxic or inert gas, or a lithium metal.

In addition, another object thereof is to provide a method of regenerating a spent secondary battery cathode using the regeneration solution, or a method of regenerating a regeneration solution by simply mixing a used regeneration solution with a lithium-containing reducing material after regenerating a cathode material.

However, goals to be achieved are not limited to those described above, and other goals not mentioned above are clearly understood by one of ordinary skill in the art from the following description.

According to an aspect, there is provided a regeneration solution of a spent secondary battery cathode, the regeneration solution including p-type redox molecules, a solvent, and a lithium salt, in which the p-type redox molecules have a reduction potential that is higher than or equal to 1.55 volt (V) and lower than or equal to 3.7 V with respect to a reduction potential of lithium (vs Li/Li⁺).

According to another aspect, there is provided a method of regenerating a spent secondary battery cathode material, the method including step S1 of preparing a regeneration solution by dissolving a lithium salt and p-type redox molecules in a solvent, step S2 of immersing a delithiated cathode material or delithiated cathode in the solution, step S3 of collecting the immersed cathode material from the solution and washing the cathode material, and step S4 of drying the cathode material.

The p-type redox molecules have a reduction potential that is higher than or equal to 1.55 V and lower than or equal to 3.7 V with respect to a reduction potential of lithium (vs Li/Li⁺).

According to still another aspect, there is provided a cathode material regenerated with the regeneration solution.

According to still another aspect, there is provided a method of recycling a regeneration solution, the method including (a) regenerating a spent secondary battery cathode material using the regeneration solution described above, and (b) mixing the used regeneration solution with a lithium-containing reducing material.

The lithium-containing reducing material is one or more selected from a group consisting of Li₂CO₃, Li₂O₂, LiO₂, LiO, Li₂O, and Li₂S.

Additional aspects of example embodiments will be set forth in part in the description which follows and, in part, will be apparent from the description, or may be learned by practice of the disclosure.

An regeneration solution according to an embodiment is stable without reactivity in a ambient environment at room temperature and atmospheric pressure and in a dry atmosphere, thereby having high mass productivity, and is capable of restoring a desired lithium composition based on high reproducibility even without necessitating information on the lithium composition of the spent cathode, and a used regeneration solution may be reused after treatment, which thus has the advantage of high economic efficiency.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a schematic view of a regeneration solution and a cathode regeneration technology using the regeneration solution according to an embodiment of the present disclosure;

FIG. 2 is a diagram illustrating the principle of a cathode regeneration technology according to an embodiment of the present disclosure;

FIG. 3 is a diagram illustrating electrochemical detection of a cathode lithium recovery reaction in a cathode regeneration technology according to an embodiment of the present disclosure;

FIG. 4 is a diagram illustrating recovery of a cathode material lattice constant through a cathode lithium recovery reaction according to an embodiment of the present disclosure; FIG. 5 is a diagram illustrating recovery of a cathode material nickel oxidation number through a cathode lithium recovery reaction according to an embodiment of the present disclosure;

FIG. 6 is a diagram illustrating a result of evaluating electrochemical characteristics of a regenerated cathode according to a concentration of lithium salt and the presence or absence of p-type redox molecules;

FIG. 7 is a diagram illustrating a result of evaluating electrochemical characteristics of a regenerated cathode according to a spent cathode material lithium composition;

FIG. 8 is a diagram illustrating a result of evaluating electrochemical characteristics of a regenerated cathode according to a spent cathode material lithium composition (highly delithiated state);

FIG. 9 is a diagram illustrating a result of evaluating electrochemical characteristics of a regenerated cathode according to the type of solvent under a dry atmosphere.

FIG. 10 is a diagram illustrating a result of evaluating lifespan characteristics of a regenerated cathode through a cathode lithium recovery reaction according to an embodiment of the present disclosure;

FIG. 11 is a diagram illustrating analysis of a lithium recovery degree according to a cathode regeneration reaction time and temperature;

FIG. 12 is a diagram illustrating a result of evaluating lifespan characteristics for a regenerated lithium nickel manganese cobalt oxide (NMC 811) cathode through a cathode lithium recovery reaction according to an embodiment of the present disclosure;

FIG. 13 is a diagram illustrating a result of analyzing an oxidation-reduction voltage by applying N,N′-diphenyl-p-phenylenediamine (DPPD) or 1,4-di-tert-butyl-2,5-dimethoxybenzene (DBB) as p-type redox molecules;

FIG. 14 is a diagram illustrating a result of evaluating a change in coulombic efficiency by applying DPPD or DBB as p-type redox molecules;

FIG. 15 is a diagram illustrating a result of evaluating a change in coulombic efficiency by applying LiPF₆ as a lithium salt of a regeneration solution;

FIG. 16 is a schematic view of a recycling process after use of a regeneration solution according to an embodiment of the present disclosure;

FIG. 17 is a diagram illustrating a result of verifying a recycling reaction after use of a regeneration solution;

FIG. 18 is a diagram illustrating a cycle of spent cathode material regeneration using a regeneration solution, subsequent recycling of the regeneration solution, and cathode material regeneration using this according to an embodiment of the present disclosure;

FIG. 19 is a diagram illustrating a result of a lifespan test of an lithium nickel manganese cobalt oxide (NMC 622) electrode regenerated using a recycled regeneration solution; and

FIG. 20 is a diagram illustrating a result of evaluating electrochemical characteristics of an NMC 622 electrode regenerated using a ferrocene-based regeneration solution prepared from various solvents (dioxolane (1,3-dioxolane; DOL), dimethyl carbonate (DMC), 2-methyltetrahydrofuran (2meTHF), acetonitrile (ACN), dimethylformamide (N,N-dimethylformamide; DMF)).

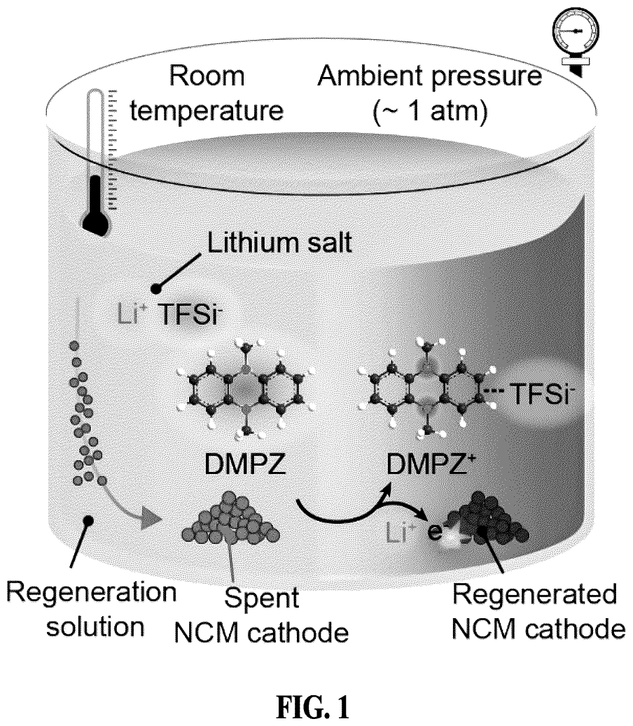

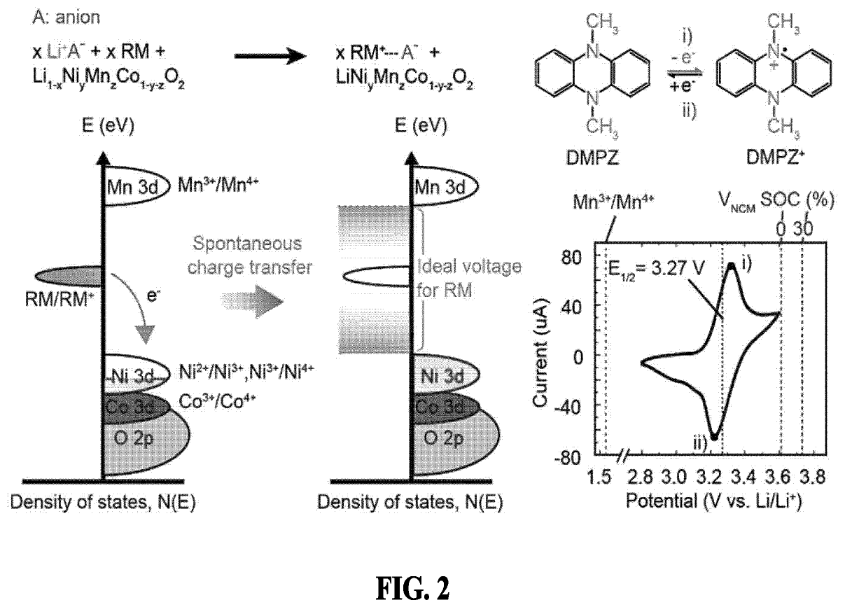

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

According to an embodiment of the present disclosure, a regeneration solution of a spent secondary battery cathode material including p-type redox molecules, a solvent, and a lithium salt, in which the p-type redox molecules have a reduction potential that is higher than or equal to 1.55 volt (V) and lower than or equal to 3.7 V with respect to lithium (vs Li/Li⁺).

When lithium ions of the lithium salt, the p-type redox molecules, and a partially delithiated cathode are mixed together, the redox molecules are oxidized, the cathode active material is reduced, and the lithium ions and electrons move from the p-type redox molecules to the cathode through a thermodynamic spontaneous reaction.

Through this principle, lithium may be inserted into the delithiated cathode of the spent secondary battery.

Meanwhile, the p-type redox molecules for causing a spontaneous reaction are i) required to be oxidized in a neutral state to exist in the form of positive ions, and ii) an oxidation/reduction potential is required to be lower than an initial charge voltage (for lithium nickel manganese cobalt oxides (NMC), 3.7 V) of the cathode, and iii) required to be higher than the reduction potential (for NMC, Mn³⁺/Mn⁴⁺ reduction potential of 1.55 V) causing a material deterioration due to excessive lithium insertion.

Specifically, the p-type redox molecules may have a reduction potential of higher than or equal to 1.55 V and lower than or equal to 3.7 V, and more desirably higher than or equal to 2.9 V and lower than or equal to 3.6 V. On the other hand, when the reduction potential is lower than 2.9 V described above, the p-type redox molecules may react with oxygen (˜2.96V) existing in the atmosphere, and thus, the use thereof in the atmosphere may be restricted.

Examples of the type of the p-type redox molecules that satisfy all of the above conditions i) to iii) may include molecules of N,N′-substituted phenazine, phenoxazine, phenylamine, phenothiazine, carbazole, phenylamine, thianthrene, dibenzodioxin, viologen, a nitroxide radical compound, polyaniline, polythiophene, polytriphenylamine, polydiphenylamine, ferrocene, manganocene, and the like, and the molecules may be substituted with one or more of an alkyl group (—R) having 1 to 5 carbon atoms, a hydroxy group (—OH), an amine group (—NH₂), a phenyl group (—Ph), a benzoate group (—BzO), an acetyl group (—CH₃CO), a carboxyl group (—COOH), and a benzoyl group (—COC₆H₅). Meanwhile, among these, more specifically, examples of the nitroxide radical compound may include proxyl, nitroxylbenzene, nitronylnitroxyl, 2,2,6,6-tetramethylpiperidinyloxyl (TEMPO), and the like.

In an embodiment of the present disclosure, the desirable type of the p-type redox molecules may correspond to 5,10-dihydro-5,10-dimethylphenazine (DMPZ), N,N′-diphenyl-p-phenylenediamine (DPPD), ferrocene, or manganocene, that may be oxidized in a neutral state to exist in the form of positive ions, and may cause an oxidation/reduction reaction at approximately 3.27˜3.45 V.

The solvent included in the regeneration solution according to an embodiment of the present disclosure may include a cyclic ether-based solvent, a linear ether-based solvent, a carbonate-based (ester-based) solvent, acetonitrile (ACN), dimethyl sulfoxide (DMSO), dimethyl formamide (DMF), dimethyl acetamide (DMAC), water (H₂O), and the like.

The solvents described above may correspond to solvents that are stable at a cathode operating potential, may dissolve a lithium salt and redox molecules, and do not cause side reactions.

Examples of specific types of the cyclic ether-based solvent may include tetrahydropyran, dioxolane, methyldioxolane, dimethyldioxolane, vinyldioxolane, methoxydioxolane, ethylmethyldioxolane, oxane, dioxane, trioxane, tetrahydrofuran, methyltetrahydrofuran, dimethyltetrahydrofuran, dimethoxytetrahydrofuran, ethoxytetrahydrofuran, ethyltetrahydrofuran, methyltetrahydropyran, dimethyltetrahydropyran, dihydropyran, tetrahydropyran, hexamethylene oxide, furan, dihydrofuran, dimethoxybenzene, dimethyloxetane, and the like.

Examples of specific types of the linear ether-based solvent may include dimethyl ether, diethyl ether, ethyl methyl ether, ethyl propyl ether, dipropyl ether, diisopropyl ether, dibutyl ether, diisobutyl ether, ethyl tert-butyl ether, dimethoxymethane, trimethoxymethane, dimethoxyethane (DME), diethoxyethane, dimethoxypropane, diethylene glycol dimethyl ether, diethylene glycol ethylmethyl ether, diethylene glycol isopropylmethyl ether, diethylene glycol butylmethyl ether, diethylene glycol diethyl ether, diethylene glycol tertbutylethyl ether, triethylene glycol dimethyl ether, tetraethylene glycol dimethyl ether, ethylene glycol ethylmethyl ether, ethylene glycol divinyl ether, diethylene glycol divinyl ether, triethylene glycol divinyl ether, methoxypropane, and the like.

Examples of specific types of the carbonate-based solvent may include dimethyl carbonate, ethylmethyl carbonate, diethyl carbonate, ethylene carbonate, propylene carbonate, vinylene carbonate, methyl acetate, ethyl acetate, propyl acetate, butyl acetate, sec-butyl acetate, t-butyl acetate, isopropyl acetate, isobutyl acetate, hexyl acetate, isoamyl acetate, methyl butyrate, ethyl butyrate, propyl butyrate, methyl lactate, ethyl lactate, methyl phenyllactate, methyl propionate, triacetin, ethyl acetoacetate, dimethyl adipate, benzyl benzoate, ethyl formate, and the like.

The lithium salt included in the regeneration solution according to an embodiment of the present disclosure is not particularly limited as long as it is a material which may be dissolved in the solvent to provide lithium ions to the delithiated cathode material. Specifically, examples thereof may include lithium bistrifluoromethanesulfonylimide (LiTFSI), lithium hexafluorophosphate (LiPF₆), lithium bisfluorosulfonylimide (LiFSI), lithium trifluoromethanesulfonate (LiTf), lithium trifluoromethanesulfone (LiOTF), lithium tetrafluoroborate (LiBF₄), lithium perchlorate (LiClO₄), lithium hexafluoroarsenate (LiAsF₆), lithium difluorooxalatomorate (LiDFOB), lithium bisoxalatoborate (LiBOB), lithium chloride (LiCl), lithium nitrate (LiNO₃), lithium sulfate (LiSO₄), lithium acetate (LiOAc), and the like, and more specifically, it is desirable to use a lithium salt including LiTFSI or LiPF₆.

Examples of the type of the cathode material, into which the lithium ions may be inserted through the regeneration solution according to an embodiment of the present disclosure may include Li[NiCoMn]O₂, LiCoO₂, Li[NiCoAl]O₂, Li[NiCoMnAl]O₂, doped-Li[NiCoMn][M]O₂, LiMn₂O₄, LiFePO₄, Li[FeMn]PO₄, LiNi_{0.5}Mn_{1.5}O₄, and the like, and more specifically, may include Li[NiCoMn]O₂ (NMC) having a charge start voltage of approximately 3.7 V, LiCoO₂ (LCO) having an initial charge voltage of approximately 3.9 V, Li[NiCoAl]O₂ (NCA) having an initial charge voltage of approximately 3.6 V, LiFePO₄ (LFP) having an initial charge voltage of approximately 3.4 V, and the like.

Meanwhile, according to an embodiment of the present disclosure, a method of regenerating a spent secondary battery cathode material including: step S1 of preparing a regeneration solution by dissolving a lithium salt and p-type redox molecules in a solvent, step S2 of immersing a delithiated cathode material or a delithiated cathode in the solution, step S3 of collecting the immersed cathode material from the solution and washing the cathode material, and step S4 of drying the cathode material, in which the p-type redox molecules have a reduction potential that is higher than or equal to 1.55 V and lower than or equal to 3.7 V with respect to lithium (vs Li/Li⁺).

The lithium salt, the p-type redox molecules, and the solvent used in the regeneration method may be substantially the same as those described in the regeneration solution of the spent secondary battery cathode material described above in detail. Desirably, the lithium salt may include one or more of LiTFSI and LiPF₆, the p-type redox molecules may include one or more of DMPZ, DPPD, ferrocene, and manganocene, and the solvent may include one or more of DME and methyltetrahydrofuran.

In the method of regenerating the spent secondary battery cathode material, as in the examples described in detail below, when the regeneration solution is prepared by dissolving LiTFSI and DMPZ in DME, the following reaction may occur when the delithiated cathode material is immersed in the regeneration solution. Through this, a regenerated cathode material having a recovered lithium composition may be obtained.

xDMPZ+xLi⁺+xTFSI⁻+Li_{1-y}[NiCoMn]O₂→x(DMPZ⁺−TFSI⁻)+Li_{1-y+x}[NiCoMn]O₂(0<x≤y)

Meanwhile, in the immersing of the cathode material in the prepared regeneration solution, a reaction may occur at room temperature (about 25° C.) and room pressure (about 1 atm) in a dry atmosphere without a separate process of a heat treatment, a base treatment, or a toxic gas treatment. An immersing time may be more than or equal to 0.25 hours, and an upper limit thereof is not particularly limited and may be, for example, more than or equal to 0.25 hours and less than or equal to 10 hours, or more than or equal to 0.5 hours and less than or equal to 5 hours.

The method of regenerating the cathode material according to an embodiment of the present disclosure has advantages of high mass productivity and reproducibility, since a reaction easily and stably occurs, insertion of an excessive amount of lithium does not occur, and a lithium insertion reaction occurs only until a potential of the cathode material reaches an oxidation/reduction potential of the p-type redox molecules, only by simply immersing the cathode material in a solution without the use of a separate lithium metal or quantification of the lithium composition.

The cathode material used in the method of regenerating the spent secondary battery cathode material is not particularly limited as long as it is partially or entirely delithiated, and for example, it may indicate that lithium of about 5% or more of an initial lithium amount in the cathode material may be delithiated.

In this case, the regeneration solution used with the cathode material may include a lithium salt and p-type redox molecules each corresponding to 1.5 times or more of lithium deficiency of the cathode material, and an upper limit thereof is not particularly limited and may be 20 times or less, specifically 10 times or less, and more specifically 3 times or more and 5 times or less.

After performing the immersing, a process of collecting and washing the cathode material is performed. The washing may be performed using the same type of solvent as the solvent previously used in the regeneration solution. Through this, a residual lithium salt and p-type redox molecules such as DMPZ, which remain with the regenerated cathode material, may be removed, and then, through a drying process, the regenerated cathode material may be used in manufacturing an electrode.

Meanwhile, according to an embodiment of the present disclosure, the regeneration solution used for regenerating the cathode material may be mixed with a lithium-containing reducing material to reduce redox molecules and filtered, thereby providing a recycling method capable of using the used regeneration solution as the regeneration solution again.

At this time, the used lithium-containing reducing material may be Li₂CO₃, Li₂O₂, LiO₂, LiO, Li₂O, Li₂S, or the like, and through this, the recycling of the regeneration solution is also possible in addition to the regeneration of the cathode material, and thus, it is advantageous that higher economic efficiency may be ensured.

Hereinafter, the configuration of the present disclosure and effects thereof will be described in more detail through examples and comparative examples. However, the examples are merely intended for the purpose of describing the disclosure in more detail, and thus, the scope of the disclosure is not limited to the examples.

### EXAMPLE

### 1. Preparation Example: Preparation of Regeneration Solution

LiTFSI and DMPZ were dissolved in a DME solvent to prepare a regeneration solution.

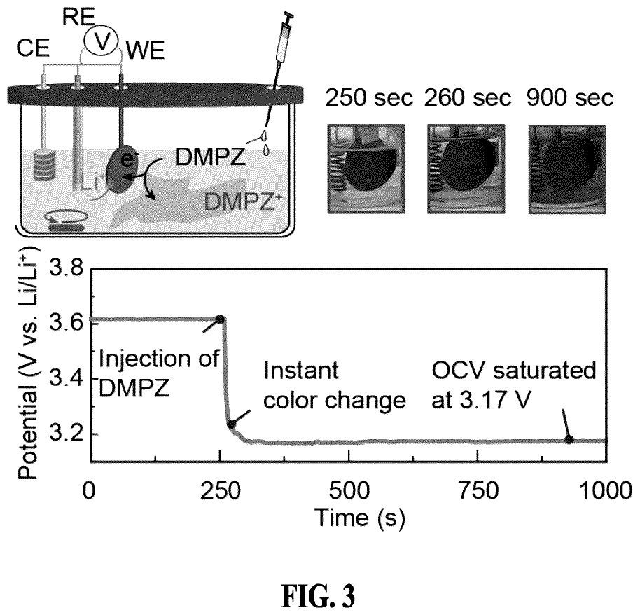

### 2. Test Example 1: Electrochemical Detection of Cathode Lithium Recovery Reaction (FIG. 3)

In a three-electrode system, in which an NMC 622 electrode charged to 30% of reversible capacity was used as a working electrode, platinum was used as a counter electrode, and lithium was used as a reference electrode, DMPZ was added to an electrolyte, in which only LiTFSI existed, and a change of a voltage over time was observed (FIG. 3).

As shown in FIG. 3, immediately after preparing a solution of 21 mM DMPZ and 22.5 mM LiTFSI by injecting DMPZ to the LiTFSI electrolyte, a color of the solution was rapidly changed to dark green. A voltage of the working electrode also rapidly decreased from 3.6 V or more to 3.17 V and converged after DMPZ was injected.

3.17 V, at which an open-circuit voltage of the working electrode converges, is a value close to an oxidation-reduction voltage of DMPZ, and it was confirmed that, through the change of the color and the converging voltage value, lithium was inserted to the NMC active material by oxidation of DMPZ and the voltage of the working electrode was lowered.

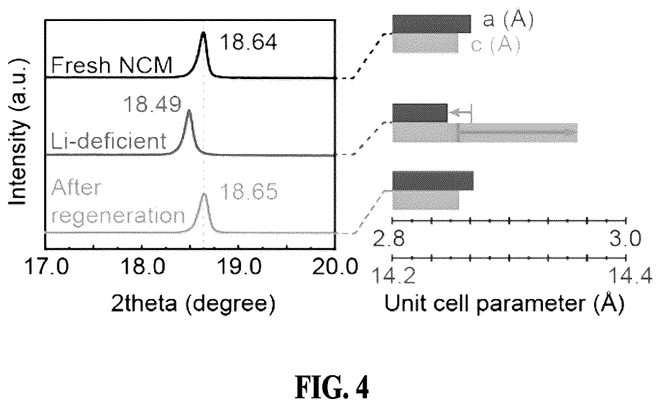

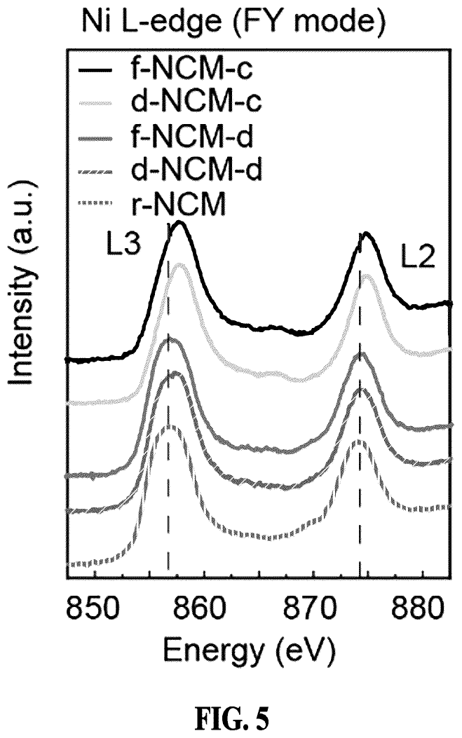

### 3. Test Example 2: Observation of Cathode Material Lattice Constant and Cathode Material Nickel Oxidation Number Recovery Through Cathode Lithium Recovery Reaction (FIGS. 4 and 5)

### (1) Cathode Material Lattice Constant Recovery (FIG. 4)

A new NMC 622 electrode, an NMC 622 electrode charged to 30% of reversible capacity after two times of charge and discharge, and an electrode regenerated by immersing it, for 2 hours, in a 140 mM DMPZ+LiTFSI regeneration solution in an argon atmosphere at room temperature, that is 10 times the amount of lithium deficiency after charging to 30%, were subjected to X-ray diffraction (XRD) analysis.

As shown in FIG. 4, a (003) peak of the new electrode was at a highest degree of 18.64 degrees, the peak after charging to 30% was moved to a smaller degree and observed at 18.49 degrees, and the peak after the regeneration was observed at 18.65 degrees that is similar to the peak of the new electrode.

Through the recovery of the (003) peak position of the electrode charged to 30% to be similar to the new NMC 622 electrode after the regeneration, it was found that, as lithium was inserted to the active material after the regeneration to recover a lattice structure, an increased lattice constant of a c axis due to the delithiation decreased, and a decreased lattice constant of an a axis increased.

### (2) Cathode Material Nickel Oxidation Number Recovery (FIG. 5)

A difference of the lithium composition of the active material for each sample was analyzed by comparing oxidation numbers of nickel present in the NMC 811 active material for each sample through near-edge X-ray absorption fine structures (NEXAFS) analysis.

A new pouch cell (f-NMC) and a pouch cell having capacity reduced by 20% due to degradation (d-NMC) were discharged before the cell disassembly to prepare f-NMC-d and d-NMC-d in a fully discharged state. Each separated cathode was charged after newly assembling a coin cell to prepare f-NMC-c and d-NMC-c in a charged state. In addition, the cathode active material was separated from the degraded pouch cell, immersed, for 2 hours, in a regeneration solution of 140 mM DMPZ+LiTFSI, that is 3 times the amount of lithium deficiency in a dry atmosphere at room temperature, and fabricated into an electrode (r-NMC), and NEXAFS analysis results of five samples were compared.

As shown in FIG. 5, an L3 peak of nickel of r-NCM and f-NCM-d appears at 857 electronvolts (eV), indicating a high lithium content and low (reduced) nickel oxidation number in the cathode. And L3 peak of nickel of f-NCM-c and d-NCM-c appears at 858 eV, indicating a low lithium content and high (oxidized) nickel oxidation number in cathode. Given the fact that the L3 peak of r-NCM is at a lower energy than d-NCM-d, it is found that the oxidation number of nickel is recovered as a sufficient amount of lithium is inserted into the cathode material after the regeneration treatment.

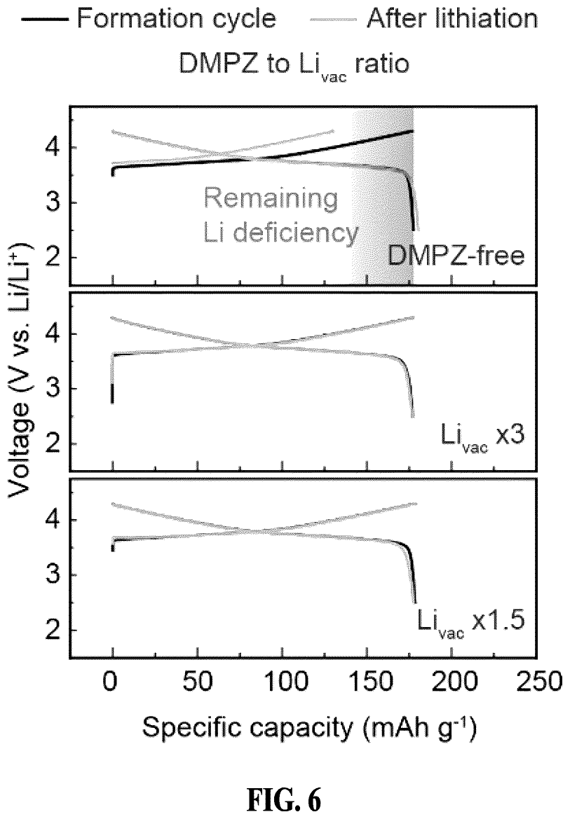

### 4. Test Example 3: Evaluation Experiment of Electrochemical Characteristics of Regenerated Cathode According to Recycling Conditions (FIGS. 6 to 10)

(1) Evaluation Result of Electrochemical Characteristics of Regenerated Cathode According to Concentration of Lithium Salt and Presence or Absence of p-type Redox Molecules (FIG. 6)

An NMC 622 coin cell was charged and discharged two times and then charged to 30% of reversible capacity, and the NMC 622 electrode was separated. After that, the cathode was regenerated by immersing, for 2 hours, in a solution containing only LiTFSI without DMPZ (0.14 M LiTFSI) and a regeneration solution containing DMPZ in an argon atmosphere at room temperature. The regeneration solutions (0.021 M DMPZ+0.021 M LiTFSI) containing DMPZ, each corresponding to the amount of 3 times (0.042 M DMPZ+0.042 M LiTFSI) and 1.5 times the lithium deficiency of the cathode were used.

Each regenerated electrode treated under the three conditions was used as a cathode, a lithium metal chip was punched to have a diameter of 16 mm and used as an anode, celgard was used as a separator, and an electrolyte of 1 M LiPF₆EC/DEC was used to manufacture a CR2032 type battery. The battery was charged and discharged at a current density of 0.1 C in a range of a charge upper voltage of 4.3 V and a discharge lower voltage of 2.5 V at room temperature of 30° C. to evaluate a change in coulombic efficiency according to recycling.

As shown in FIG. 6, when reassembled after immersing the electrode in a solution without DMPZ, first charge capacity decreased to 130 mAh g⁻¹ was shown, indicating no lithium insertion, however, when the electrode was immersed in a regeneration solution containing DMPZ, the charge capacity was recovered by an amount of 100.5% in a case where the amount of DMPZ was 3 times the lithium deficiency, and was recovered by an amount of 100.4% in a case where the amount of DMPZ was 1.5 times. Through this, it was confirmed that the charge capacity is recovered close to 100% regardless of the amount of DMPZ with respect to the lithium deficiency if the amount of DMPZ is larger than the lithium deficiency.

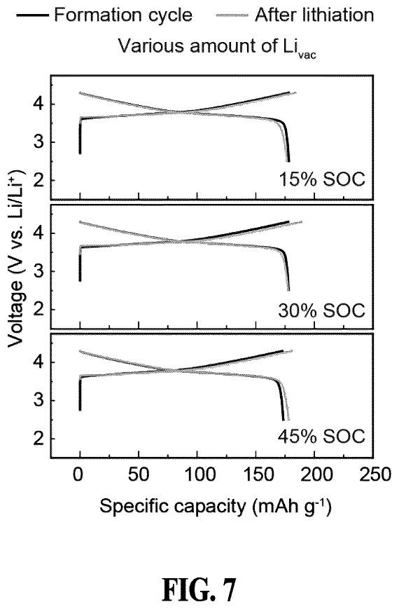

### (1) Evaluation Result of Electrochemical Characteristics of Regenerated Cathode According to Lithium Composition of Non-Homogeneous Spent Cathode Material (FIG. 7)

Three NMC 622 coin cells were charged and discharged two times and then charged to 15%, 30%, and 45% of reversible capacity, respectively, and the NMC electrodes were separated. After the NMC electrodes were separated, the three electrodes were immersed together in a regeneration solution (0.14 M DMPZ+0.14 M LiTFSI) in an argon atmosphere at room temperature for 1 hour and regenerated. The amount of regeneration solution corresponding to 10 times the sum of the lithium deficiency of the three cathodes was used.

Each regenerated electrode treated under the above three conditions was used as a cathode, a lithium metal chip was punched to have a diameter of 16 mm and used as an anode, celgard was used as a separator, and an electrolyte of 1 M LiPF6 EC/DEC was used to manufacture a CR2032 type battery. The batteries were charged and discharged at a current density of 0.1 C in a range of a charge upper voltage of 4.3 V and a discharge lower voltage of 2.5 V at room temperature of 30° C. to evaluate a change in coulombic efficiency according to recycling.

As shown in FIG. 7, after concurrently immersing the electrodes in the regeneration solution for regeneration, the electrodes charged to 15%, 30%, and 45% of reversible capacity were respectively recovered the first charge capacity of 103%, 106%, and 104% after the reassembly. And, it was confirmed that the coulombic efficiency was recovered close to 100%. The result verifies that the regeneration solution is capable of regenerating the spent cathode materials with the non-homogeneous lithium composition.

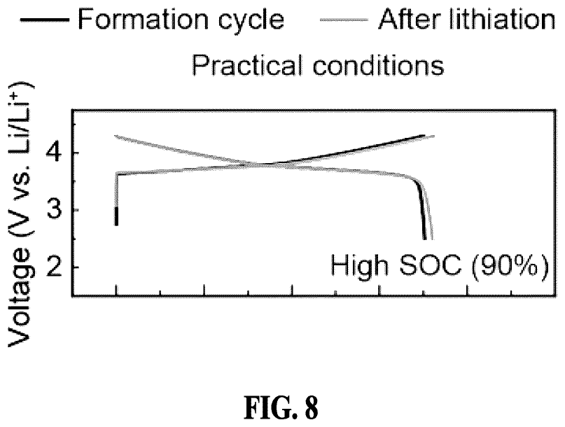

### (3) Evaluation Result of Electrochemical Characteristics of Regenerated Cathode According to Lithium Composition of Spent Cathode Material (Highly Delithiated State) (FIG. 8)

An NMC 622 coin cell was charged and discharged two times and then charged to 90% of reversible capacity, and the NMC electrode was separated. After the NMC electrode was separated, the amount of a regeneration solution (0.14 M DMPZ+0.14 M LiTFSI) corresponding to 10 times the lithium deficiency of the spent cathode in an argon atmosphere at room temperature for 2 hours was used for regeneration.

The regenerated electrode treated under the above condition was used as a cathode, a lithium metal chip was punched to have a diameter of 16 mm and used as an anode, celgard was used as a separator, and an electrolyte of 1 M LiPF₆EC/DEC was used to manufacture a CR2032 type battery. The battery was charged and discharged at a current density of 0.1 C in a range of a charge upper voltage of 4.3 V and a discharge lower voltage of 2.5 V at room temperature of 30° C. to evaluate a change in coulombic efficiency according to recycling.

As shown in FIG. 8, after immersing the electrode in the regeneration solution for regeneration, the electrode charged to 90% of reversible capacity showed the first charge capacity after the reassembly of 103%. Through this, it was confirmed that, the regeneration is able to be successfully performed even when the amount of lithium deficiency of the spent cathode is large.

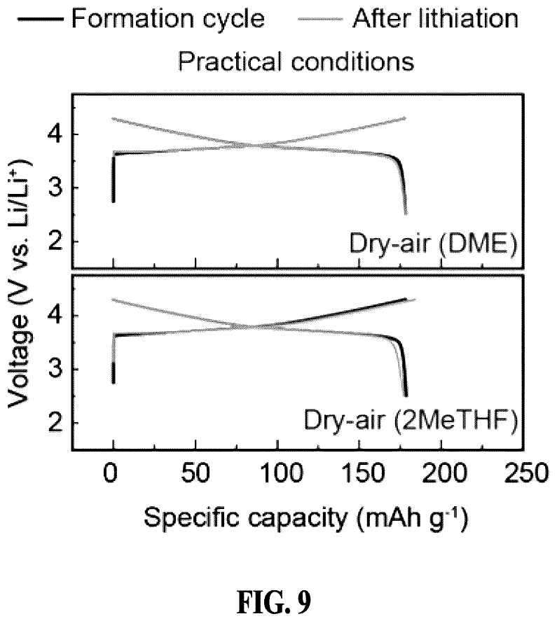

### (4) Evaluation Result of Electrochemical Characteristics of Regenerated Cathode According to Type of Solvent in Dry Atmosphere (FIG. 9)

An NMC 622 coin cell was charged and discharged two times and then charged to 30% of reversible capacity, and the NMC electrode was separated. After the NMC electrode was separated, the electrode was immersed in a regeneration solution using a DME or 2-meTHF solvent in a dry atmosphere at room temperature for 2 hours and regenerated. The amount of a regeneration solution (0.14 M DMPZ+0.14 M LiTFSI) corresponding to 10 times the lithium deficiency of the cathode was used.

Each regenerated electrode treated under the above condition with two solvents was used as a cathode, a lithium metal chip was punched to have a diameter of 16 mm and used as an anode, celgard was used as a separator, and an electrolyte of 1 M LiPF₆EC/DEC was used to manufacture a CR2032 type battery. The battery was charged and discharged at a current density of 0.1 C in a range of a charge upper voltage of 4.3 V and a discharge lower voltage of 2.5 V at room temperature of 30° C. to evaluate a change in coulombic efficiency according to recycling.

The electrodes regenerated with different solvents of DME and 2-meTHF in the dry atmosphere exhibited first coulombic efficiencies of 100% and 103%, respectively. Through this, it was confirmed that, even when the regeneration was performed in a state of being exposed to the dry atmosphere or the regeneration solution using different solvents was used, an active material was successfully regenerated.

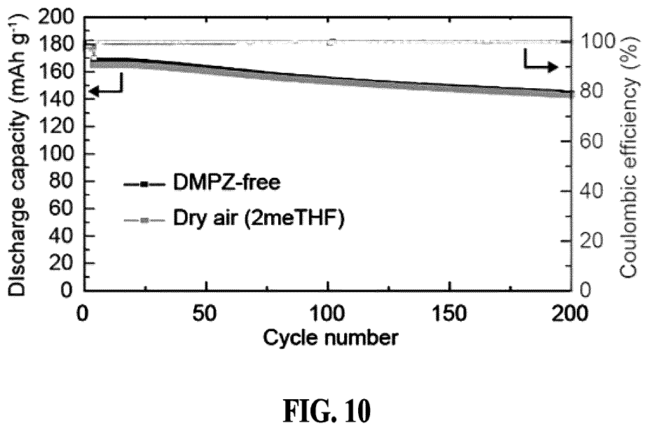

### (5) Evaluation of Lifespan Characteristics of Regenerated Cathode (FIG. 10)

An NMC 622 coin cell was charged and discharged two times and then charged to 30% of reversible capacity, and the NMC electrode was separated and immersed in a regeneration solution (0.14 M DMPZ+0.14 M LiTFSI) using a solvent of 2-meTHF in a dry atmosphere at room temperature for 2 hours and regenerated. The amount of the regeneration solution corresponding to 10 times the lithium deficiency of the cathode was used. In addition, in order to observe a degradation of the electrode during the regeneration process, a sample (DMPZ-free) with an immersed electrode charged under the same condition using a solution of 0.14 M LiTFSI without DMPZ was prepared.

Each electrode treated under the above condition was used as a cathode, a lithium metal chip was punched to have a diameter of 16 mm and used as an anode, celgard was used as a separator, and an electrolyte of 1 M LiPF₆EC/DEC was used to manufacture a CR2032 type battery. The battery was charged and discharged at a current density of 0.1 C in three cycles and then at a current density of 0.5 C in a range of a charge upper voltage of 4.3 V and a discharge lower voltage of 2.5 V at room temperature of 30° C. to evaluate a change in lifespan characteristic according to recycling.

As shown in FIG. 10, the electrode regenerated using the solvent of 2-meTHF in the dry atmosphere maintained capacity of 85.9% after 200 cycles, and it was confirmed that there was no significant difference from a capacity maintaining rate of 86.3% of the electrode treated without DMPZ. Through this, it was confirmed that the regeneration treatment did not adversely affect the lifespan of the anode.

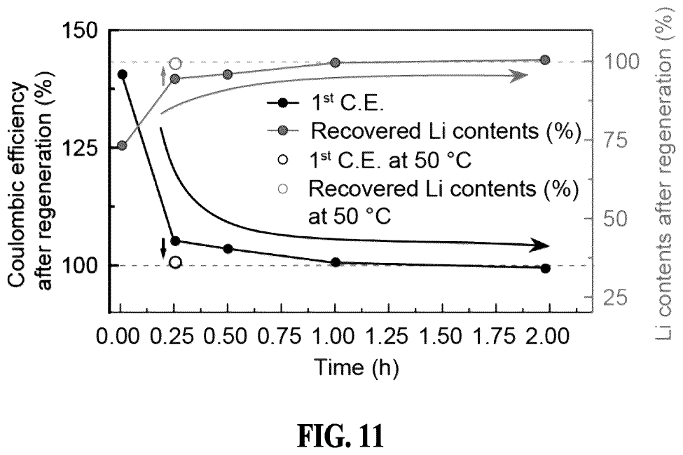

### 5. Test Example 4: Analysis of Lithium Recovery Degree According to Cathode Regeneration Reaction Time (FIG. 11)

An NMC 622 coin cell was charged and discharged two times and then charged to 30% of reversible capacity, and the NMC electrode was separated. A regeneration degree according to an immersion time was compared by setting different times for immersing the NMC electrode in a regeneration solution of 0.042 M DMPZ+0.042 M LiTFSI based on DME in the argon atmosphere at room temperature. In a case of an electrode immersed for 0.25hours, the treatment was performed at two different temperatures of room temperature and 50° C. to compare a regeneration degree according to a temperature together.

The electrode treated under each time condition described above was used as a cathode, a lithium metal chip was punched to have a diameter of 16 mm and used as an anode, celgard was used as a separator, and an electrolyte of 1 M LiPF₆EC/DEC was used to manufacture a CR2032 type battery. The battery was charged and discharged at a current density of 0.1 C in a range of a charge upper voltage of 4.3 V and a discharge lower voltage of 2.5 V at room temperature of 30° C.

As shown in FIG. 11, as the time of immersing the electrode in the solution increased from 0.25 hours to 2 hours, the coulombic efficiency converged to 100% and was saturated when the time elapsed about 1 hour. In addition, when the active material was regenerated at 50° C., the charge capacity saturated close to 100% was recovered in 15 minutes. Through this, it was confirmed that more rapid regeneration was possible by raising the temperature.

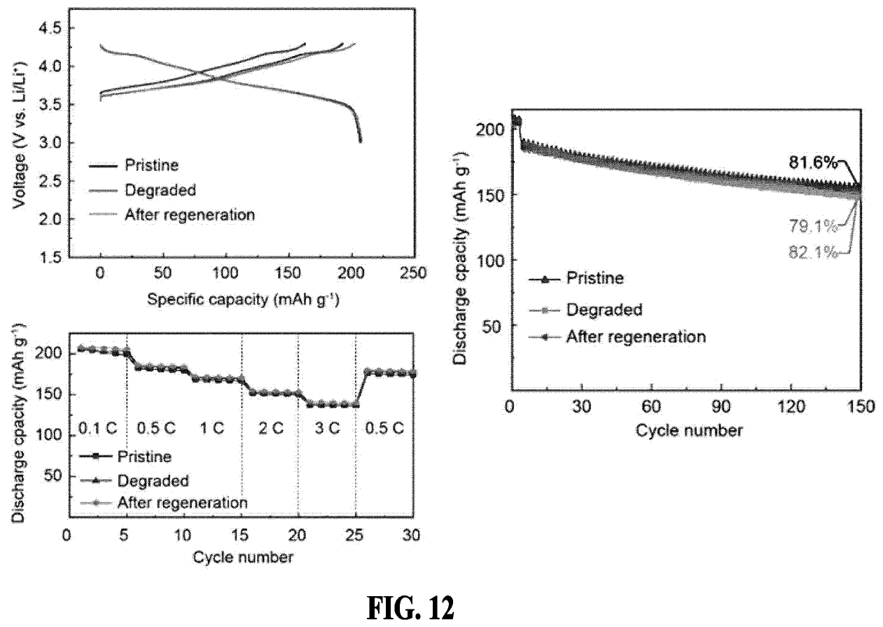

### 6. Test Example 5: Evaluation Result of Rate Capability and Lifespan Characteristics According to Type of Cathode Material (FIG. 12)

A cathode powder of LiNi_{0.8}Mn_{0.1}Co_{0.1}O₂ (NMC 811) collected from a new pouch cell (a, pristine), a cathode powder collected from a pouch cell having capacity reduced by 20% (b, degraded), and a powder (c, after regeneration) obtained by regeneration by immersing the corresponding cathode in a regeneration solution (0.14M DMPZ+0.14M LiTFSI), the amount of which is three times lithium deficiency in a dry atmosphere at room temperature for 2 hours, were mixed with N-methyl-2-pyrrolidone (NMP), polyvinylidene fluoride (PVDF), and Super P to manufacture three NMC 811 cathodes in total.

The NMC 811 electrode was punched to have a diameter of 11.3 mm and used as a cathode, a lithium metal chip was punched to have a diameter of 16 mm and used as an anode, celgard was used as a separator, and an electrolyte of 1 M LiPF₆EC/DEC was used to manufacture a CR2032 type battery. The battery was charged and discharged at a current density of 0.1 C in three cycles and then at a current density of 0.5 C in a range of a charge upper voltage of 4.3 V and a discharge lower voltage of 3.0 V at room temperature of 30° C. to evaluate the lifespan characteristics according to recycling. In addition, in order to confirm the difference in rate capability according to whether the battery was recycled, the rate capability was evaluated by changing the rate in the order of 0.1 C, 0.5 C, 1 C, 2 C, 3 C, and 0.5 C.

As shown in FIG. 12, the degraded NMC 811 cathode showed capacity of 159.1 mAh g⁻¹ reduced by 18.1% from the first charge with respect to the new cathode, and showed 202.3mAh g⁻¹ after the regeneration, which shows the recovery of the first charge capacity. Even after charging and discharging for 150 cycles, there was no difference in the capacity maintaining rate between the new cathode and regenerated cathode.

In addition, since the same rate capability was obtained under the condition of the current densities of 0.1 C to 3 C regardless of whether the recycling treatment is performed, it was confirmed that the spent cathode regeneration treatment is able to be applied to NMC 811regardless of the type of the cathode material and it does not affect the rate capability of the active material.

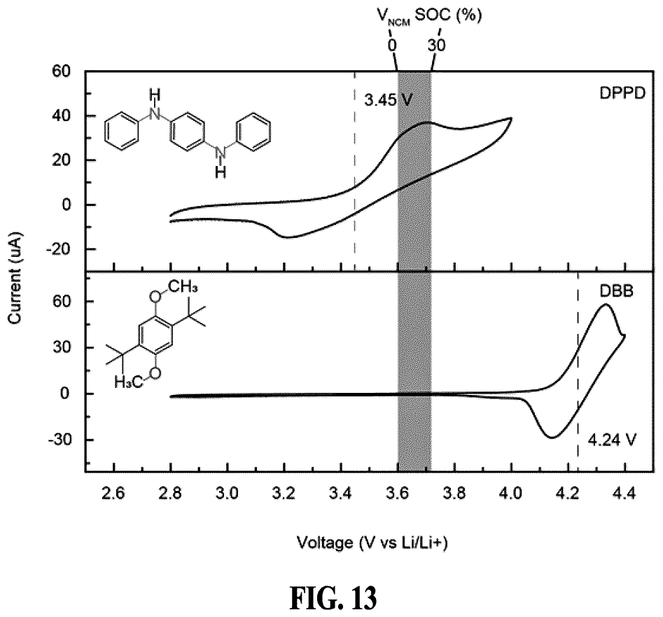

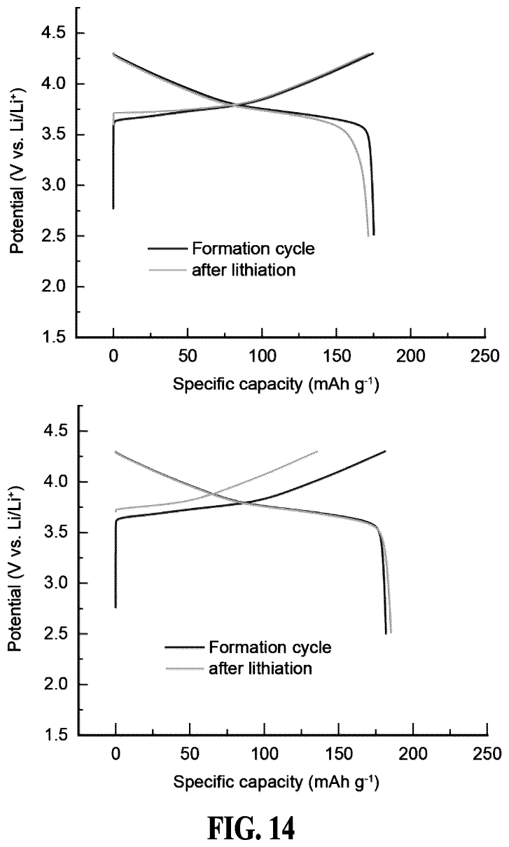

### 7. Test Example 6: Experiment According to Type of p-type Redox Molecules (FIGS. 13 and 14)

(1) Analysis of Oxidation-Reduction Voltage According to Application of DPPD or 1,4-di-tert-butyl-2,5-dimethoxybenzene (DBB) (FIG. 13)

An oxidation-reduction voltage of each redox molecule was analyzed through cyclic voltammetry (CV) of a regeneration solution in which 21 mM of DPPD or DBB was used as the p-type redox molecules and 21 mM of LiTFSI was used as a lithium salt.

After 30 mL of the regeneration solution was injected as an electrolyte into a coin cell using a stainless steel plate having a diameter of 16 pi as a working electrode, a lithium metal chip punched to have a diameter of 16 mm as an anode, and celgard as a separator, a voltage was scanned at a rate of 1 mV s⁻¹.

As shown in FIG. 13, it was confirmed that DPPD showed a reduction potential of 3.45 V which is a sufficiently low reduction potential, and thus was able to be used as the p-type redox molecules of a recycling solution, whereas DBB had a reduction potential of 4.25 V which is higher than 3.6 V, a charge starting voltage of NMC, and thus, it was inappropriate to be used as the p-type redox molecules of the regeneration solution.

### (2) Evaluation of Change in Coulombic Efficiency According to DPPD or DBB Application (FIG. 14)

An NMC 622 coin cell was charged and discharged two times and then charged to 30% of reversible capacity, and the NMC electrode was separated. After separating the NMC electrode, the cathode was immersed in a regeneration solution (0.14M DPPD+0.14 M LiTFSI) (a) using DPPD and a regeneration solution (0.14 M DBB+0.14 M LiTFSI) (b) using DBB in the argon atmosphere at room temperature for 0.25 hours and regenerated. The amount of the regeneration solution corresponding to 10 times the lithium deficiency of the cathode was used.

Each electrode treated under the above condition was used as a cathode, a lithium metal chip was punched to have a diameter of 16 mm and used as an anode, celgard was used as a separator, and an electrolyte of 1 M LiPF₆EC/DEC was used to manufacture a CR2032 type battery. The battery was charged and discharged at a current density of 0.1 C in a range of a charge upper voltage of 4.3 V and a discharge lower voltage of 2.5 V at room temperature of 30° C. to evaluate a change in coulombic efficiency according to recycling.

As shown in FIG. 14, while first coulombic efficiency recovered to 98.3% was exhibited after immersing the electrode in the solution using DPPD (upper graph of FIG. 14), the first charge capacity of 81.3% was shown when the electrode was immersed in the regeneration solution using DBB (lower graph of FIG. 14). Through this, it was confirmed that DPPD having an appropriate reduction potential (3.45 V) is able to regenerate the cathode, but DBB having a reduction potential (4.24 V), that was not sufficiently low, is not able to regenerate an active material.

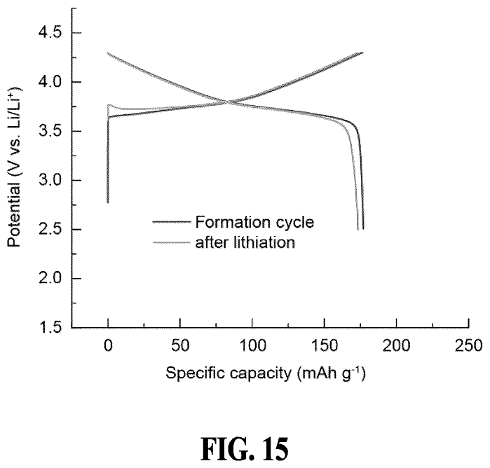

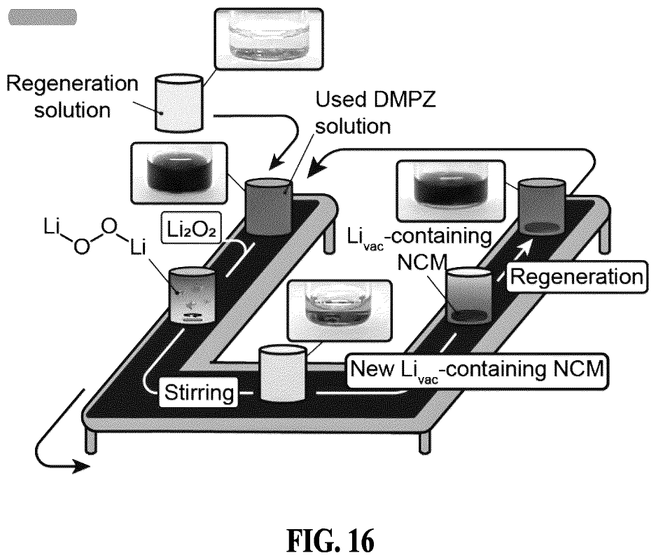

### 8. Test Example 7: Experiment of Cathode Regeneration According to Type of Lithium Salt (FIG. 15)

An NMC 622 coin cell was charged and discharged two times and then charged to 30% of reversible capacity, and the NMC electrode was separated. After the NMC electrode was separated, the cathode was immersed in a regeneration solution using LiPF₆ and DMPZ in the argon atmosphere at room temperature for 0.25 hours and regenerated. The amount of the regeneration solution (0.14 M DMPZ+0.14 M LiPF6) corresponding to 10 times the lithium deficiency of the cathode was used.

The regenerated electrode treated under the above condition was used as a cathode, a lithium metal chip was punched to have a diameter of 16 mm and used as an anode, celgard was used as a separator, and an electrolyte of 1 M LiPF₆EC/DEC was used to manufacture a CR2032 type battery. The battery was charged and discharged at a current density of 0.1 C in a range of a charge upper voltage of 4.3 V and a discharge lower voltage of 2.5 V at room temperature of 30° C. to evaluate a change in coulombic efficiency according to recycling.

As shown in FIG. 15, even when the regeneration solution using LiPF₆ was used, the first charge capacity after the reassembly was 98.2%. Through this, it was confirmed that, even when a lithium salt other than LiTFSI was used, the NMC active material is able to be successfully regenerated.

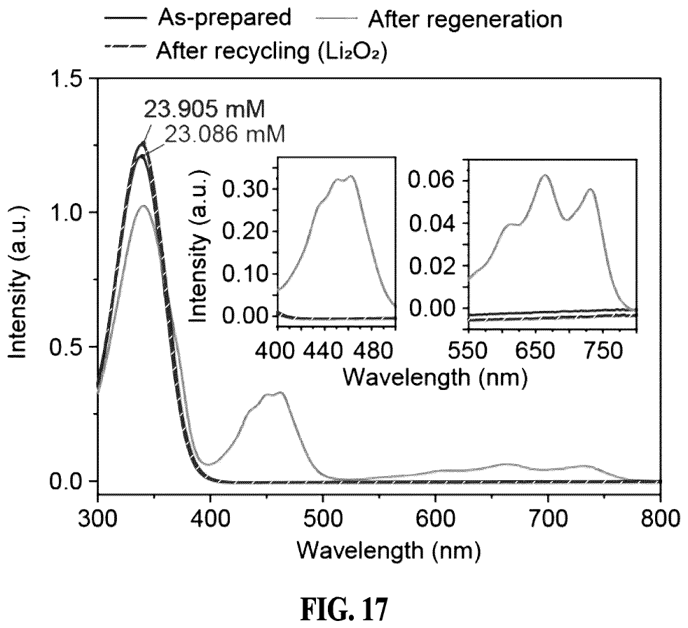

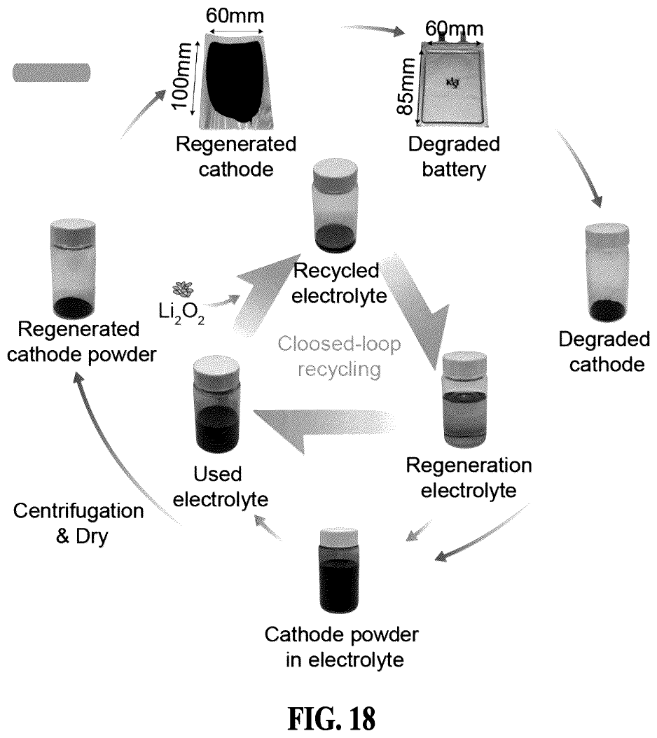

9. Test Example 8: Experiment of Verification of Recycling Reaction After Use of Regeneration Solution (FIG. 17)

Through UV-vis absorbance spectroscopy, three solutions of a new regeneration solution, a solution used to regenerate an electrode, and a solution obtained by recycling the used solution by adding Li₂O₂, were analyzed.

A peak near 339 nm indicates unoxidized neutral DMPZ, and a peak near 400-500 nm and 600-750 nm indicates oxidized DMPZ⁺. In FIG. 17, the DMPZ⁺ peak appears for a new regeneration solution containing only neutral DMPZ (as-prepared), and the DMPZ⁺ peak disappears after the restoration through Li₂O₂ (after recycling). Through this, it is found that DMPZ oxidized during the regeneration process is reduced to neutral DMPZ again during the recycling process.

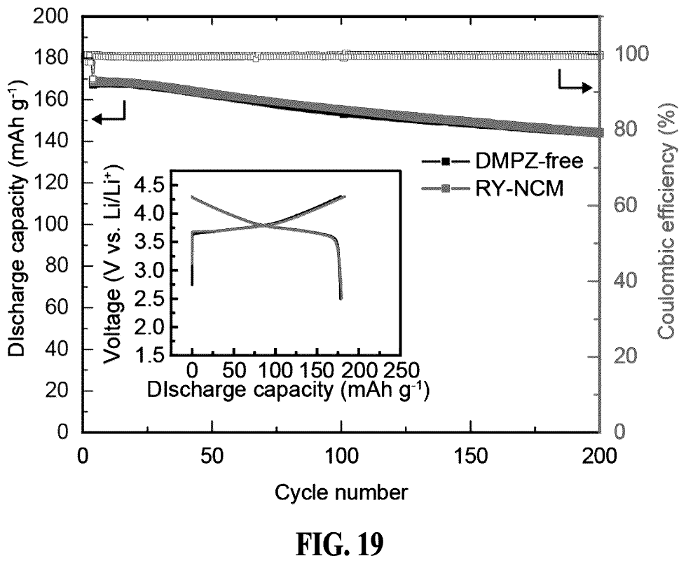

### 10. Test Example 9: Experiment of Lifespan of NMC 622 Electrode Regenerated Through Recycling of Regeneration Solution (FIG. 19)

An electrode delithiated by 30% of reversible capacity was immersed in a recycled regeneration solution in the argon atmosphere for 2 hours and regenerated (RY-NCM). The recycled regeneration solution was obtained by mixing the used regeneration solution with Li₂O₂. In addition, in order to observe a degradation of the electrode in the regeneration solution, a sample (DMPZ-free) was prepared by immersing a 30% charged electrode under the same condition in a solution of 0.14 M LiTFSI without DMPZ.

In order to prepare the used regeneration solution, an NMC 622 coin cell was charged and discharged two times and then charged to 30% of reversible capacity, and the NMC electrode was separated. After the NMC electrode was separated, the electrode was regenerated using a regeneration solution containing DMPZ and LiTFSI, the amount of which corresponds to 1.5 times the lithium deficiency of the delithiated cathode, and the used regeneration solution was collected for the recycling process.

The electrode regenerated under the above condition was used as a cathode, a lithium metal chip was punched to have a diameter of 16 mm and used as an anode, celgard was used as a separator, and an electrolyte of 1 M LiPF₆EC/DEC was used to manufacture a CR2032type battery. The battery was charged and discharged at a current density of 0.1 C for two cycles and then at a current density of 0.5 C in a range of a charge upper voltage of 4.3 V and a discharge lower voltage of 2.5 V at room temperature of 30° C. to evaluate the lifespan characteristics according to recycling of the solution.

As shown in FIG. 19, even when the electrode was regenerated using the restored regeneration solution, the first charge capacity after assembly was recovered by 102.7%, and the capacity maintaining rate was 85.3% after 200 cycles. Through this, it was confirmed that there is no adverse effect on lifespan caused by the regeneration using the recycled regeneration solution.

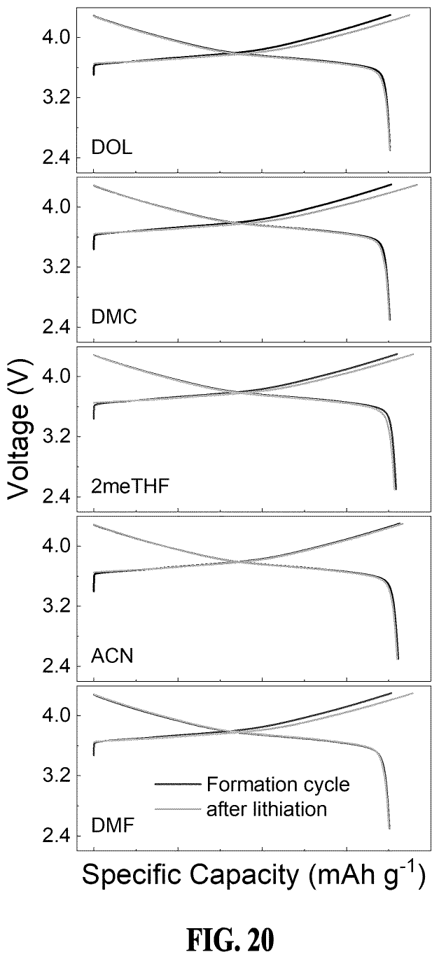

### 11. Test Example 10: Evaluation of Electrochemical Characteristics of Regenerated Cathode According to Solvent (FIG. 20)

### (1) Preparation of Regenerated NMC Cathodes

An NMC 622 coin cell was charged and discharged two times and then charged to 30% of reversible capacity, and the NMC electrode was separated. Then, the electrode was immersed in a regeneration solution (0.1 M ferrocene+0.1 M LiTFSI) in the argon atmosphere at 30° C. for 1 hour and regenerated. As a solvent of the regeneration solution, dioxolane (1,3-dioxolane), dimethyl carbonate, methyltetrahydrofuran, acetonitrile, or dimethylformamide (N,N-dimethylformamide) was used, respectively. At this time, the regeneration solution containing DMPZ and LiTFSI with an amount corresponding to 10 times the lithium deficiency in the NMC electrode active material was used.

### (2) Evaluation of Change in Coulombic Efficiency

The electrode regenerated under each solvent condition described above was used as a cathode, a lithium metal chip was punched to have a diameter of 16 mm and used as an anode, celgard 2320 was used as a separator, and an electrolyte of 1 M LiPF₆EC/DEC was used to manufacture a CR2032 type battery. The battery was charged and discharged at a current density of 0.1 C in a range of a charge upper voltage of 4.3 V and a discharge lower voltage of 2.5 V at room temperature of 30° C. to evaluate a change in coulombic efficiency according to recycling, and results thereof are shown in FIG. 20.

### (3) Evaluation of the First Charge Capacity After Reassembly of Regenerated Electrode

Electrodes regenerated using regeneration solutions of dioxolane (1,3-dioxolane), dimethyl carbonate, 2-methyltetrahydrofuran, acetonitrile, and dimethylformamide (N,N-dimethylformamide) exhibited first charge capacity after reassembly of 106.43%, 108.80%, 105.36%, 101.00%, and 107.20%, respectively. Through this, it was confirmed that the NMC electrode is able to be regenerated using various organic solvents.

While the example embodiments are described with reference to drawings, it will be apparent to one of ordinary skill in the art that various alterations and modifications in form and details may be made in these example embodiments without departing from the spirit and scope of the claims and their equivalents. For example, suitable results may be achieved if the described techniques are performed in a different order and/or if described components are combined in a different manner and/or replaced or supplemented by other components or their equivalents.

Therefore, other implementations, other embodiments, and equivalents to the claims are also within the scope of the following claims.

What is claimed is:

1. A regeneration solution of a spent secondary battery cathode material, the regeneration solution comprising:
p-type redox molecules;
a solvent; and
a lithium salt,
wherein the p-type redox molecules have a reduction potential that is higher than or equal to 1.55 volt (V) and lower than or equal to 3.7 V with respect to a reduction potential of lithium (vs Li/Li⁺).

2. The regeneration solution of claim 1, wherein the p-type redox molecules have the reduction potential that is higher than or equal to 2.9 V and lower than or equal to 3.6 V with respect to the reduction potential of lithium (vs Li/Li⁺).

3. The regeneration solution of claim 1,
wherein the p-type redox molecules comprise one or more molecules selected from a group consisting of N,N′-substituted phenazine, phenoxazine, phenylamine, phenothiazine, carbazole, phenylamine, thianthrene, dibenzodioxin, viologen, a nitroxide radical compound, polyaniline, polythiophene, polytriphenylamine, polydiphenylamine, ferrocene, and manganocene, and
wherein the molecules are able to be substituted with one or more of an alkyl group (—R) having 1 to 5 carbon atoms, a hydroxyl group (—OH), an amine group (—NH₂), a phenyl group (—Ph), a benzoate group (—BzO), an acetyl group (—CH₃CO), a carboxyl group (—COOH), and a benzoyl group (—COC₆H₅).

4. The regeneration solution of claim 1, wherein the solvent comprises one or more selected from a group consisting of a cyclic ether-based solvent, a linear ether-based solvent, a carbonate-based (ester-based) solvent, acetonitrile, dimethyl sulfoxide (DMSO), dimethylformamide (DMF), dimethylacetamide (DMAC), and water (H₂O).

5. The regeneration solution of claim 4, wherein the cyclic ether-based solvent comprises one or more selected from a group consisting of tetrahydropyran, dioxolane, methyldioxolane, dimethyldioxolane, vinyldioxolane, methoxydioxolane, ethylmethyldioxolane, oxane, dioxane, trioxane, tetrahydrofuran, methyltetrahydrofuran, dimethyltetrahydrofuran, dimethoxytetrahydrofuran, ethoxytetrahydrofuran, ethyltetrahydrofuran, methyltetrahydropyran, 1, dimethyltetrahydropyran, dihydropyran, tetrahydropyran, hexamethylene oxide, furan, dihydrofuran, dimethoxybenzene, and dimethyloxetane.

6. The regeneration solution of claim 4, wherein the linear ether-based solvent comprises one or more selected from a group consisting of dimethyl ether, diethyl ether, ethyl methyl ether, ethyl propyl ether, dipropyl ether, diisopropyl ether, dibutyl ether, diisobutyl ether, ethyl tert-butyl ether, dimethoxymethane, trimethoxymethane, dimethoxyethane, diethoxyethane, dimethoxypropane, diethylene glycol dimethyl ether, diethylene glycol ethyl methyl ether, diethylene glycol isopropyl methyl ether, diethylene glycol butyl methyl ether, diethylene glycol diethyl ether, diethylene glycol tert-butyl ethyl ether, triethylene glycol dimethyl ether, tetraethylene glycol dimethyl ether, ethylene glycol ethyl methyl ether, ethylene glycol divinyl ether, diethylene glycol divinyl ether, triethylene glycol divinyl ether, and methoxypropane.

7. The regeneration solution of claim 4, wherein the carbonate-based solvent comprises one or more selected from a group consisting of dimethyl carbonate, ethyl methyl carbonate, diethyl carbonate, ethylene carbonate, propylene carbonate, vinylene carbonate, methyl acetate, ethyl acetate, propyl acetate, butyl acetate, sec-butyl acetate, t-butyl acetate, isopropyl acetate, isobutyl acetate, hexyl acetate, isoamyl acetate, methyl butyrate, ethyl butyrate, propyl butyrate, methyl lactate, ethyl lactate, methyl phenyllactate, methyl propionate, triacetin, ethyl acetoacetate, dimethyl adipate, benzyl benzoate, and ethyl formate.

8. The regeneration solution of claim 1, wherein the lithium salt comprises one or more selected from a group consisting of lithium bistrifluoromethanesulfonylimide (LiTFSI), lithium hexafluorophosphate (LiPF₆), lithium bisfluorosulfonylimide (LiFSI), lithium trifluoromethanesulfonate (LiTf), lithium trifluoromethanesulfone (LiOTF), lithium tetrafluoroborate (LiBF₄), lithium perchlorate (LiClO₄), lithium hexafluoroarsenate (LiAsF₆), lithium difluorooxalatomorate (LiDFOB), lithium bisoxalatoborate (LiBOB), lithium chloride (LiCl), lithium nitrate (LiNO₃), lithium sulfate (LiSO₄) and lithium acetate (LiOAc).

9. The regeneration solution of claim 1, wherein the cathode material comprises one or more selected from a group consisting of Li[NiCoMn]O₂, LiCoO₂, Li[NiCoAl]O₂, Li[NiCoMnAl]O₂, doped-Li[NiCoMn][M]O₂, LiMn₂0₄, LiFePO₄, Li[FeMn]PO₄, and LiNi_{0.5}Mn_{1.5}O₄.

10. A method of regenerating a spent secondary battery cathode material, the method comprising:
step S1 of preparing a regeneration solution by dissolving a lithium salt and p-type redox molecules in a solvent;
step S2 of immersing a delithiated cathode material or delithiated cathode in the solution;
step S3 of collecting the immersed cathode material from the solution and washing the cathode material; and
step S4 of drying the cathode material,
wherein the p-type redox molecules have a reduction potential that is higher than or equal to 1.55 volts (V) and lower than or equal to 3.7 V with respect to a reduction potential of lithium (vs Li/Li⁺).

11. The method of claim 10,
wherein the lithium salt comprises one or more of lithium bistrifluoromethanesulfonylimide (LiTFSI) and lithium hexafluorophosphate (LiPF₆),
wherein the p-type redox molecules comprise one or more of 5,10-dihydro-5,10-dimethylphenazine (DMPZ), N,N′-diphenyl-p-phenylenediamine (DPPD), ferrocene, and manganese, and
wherein the solvent comprises one or more of dimethoxyethane (DME), 1,3-dioxolane (DOL), 2-methylhydrofuran (2meTHF), acetonitrile (ACN), and N,N-dimethylformamide (DMF).

12. The method of claim 10, wherein step S2 comprises immersing at room temperature and pressure for 0.25 hours.

13. The method of claim 10, wherein the delithiated cathode material is a material from which lithium of 5% or more of an initial lithium amount is delithiated.

14. The method of claim 10, wherein the regeneration solution comprises the lithium salt and the p-type redox molecules corresponding to 1.5 times or more each of lithium deficiency of the cathode material.

15. The method of claim 10, wherein the washing of step S3 is performed using the same solvent as the solvent of the regeneration solution.

16. A cathode material regenerated with the regeneration solution of claim 1.

17. A method of recycling a regeneration solution, the method comprising:
(a) regenerating a spent secondary battery cathode material using the regeneration solution of claim 1; and
(b) mixing the used regeneration solution with a lithium-containing reducing material,
wherein the lithium-containing reducing material is one or more selected from a group consisting of Li₂CO₃, Li₂O₂, LiO₂, LiO, Li₂O, and Li₂S.
